(19) United States
(12) Patent Application Publication
(10) Pub. No.: US 2026/0236514 A1
(43) Pub. Date: Aug. 13, 2026

(54) METHODS, DEVICES AND SYSTEMS FOR RERANKING DIGITAL INFORMATION WITH A MACHINE LEARNING MODEL

(71) Applicant: Primal Fusion Inc., Kitchener (CA)

(72) Inventors: Xueguang Ma, Waterloo (CA); Xinyu Zhang, Waterloo (CA); Ronak Pradeep, Waterloo (CA); Jimmy Lin, Kitchener (CA); Mathew Whitney Wilson, Kitchener (CA)

(21) Appl. No.: 19/159,230

(22) PCT Filed: Mar. 15, 2024
(86) PCT No.: PCT/CA2024/050320

§ 371 Date: Aug. 22, 2025

Related U.S. Application Data
(60) Provisional application No. 63/490,264, filed on Mar. 15, 2023.

(51) Int. Cl. G06F 16/338

(52) U.S. Cl. CPC G06F 16/338

(57) ABSTRACT

Methods, devices and systems for reranking digital information using a machine learning model are provided herein. A method for reranking digital information using a machine learning model includes receiving input data including an object of interest and a set of candidate items. The method further includes processing, by a machine learning model, the input data based on a contextual understanding of the input data. The method further includes generating output data based on the processing, wherein the output data includes candidate items ranked according to relevance to the object of interest. A device is provided configured to execute the methods disclosed herein. A system is provided configured to execute the methods disclosed herein.

### TECHNICAL FIELD

The following relates generally to information retrieval (IR) and machine learning (ML), and more particularly to systems and methods for reranking using an ML model, such as a large language model (LLM).

### INTRODUCTION

IR is a critical upstream task for many open-domain natural language understanding (NLU) applications in machine learning and artificial intelligence, such as search, question answering, fact verification, entity linking, content recommendation, and classification. IR involves finding and ranking the most relevant information, documents, or text in response to a given query. Supervised retrievers and rerankers have shown success in forming the multi-stage ranking pipeline for text ranking tasks across open domains and multiple languages. However, these methods rely on the availability of large amounts of labeled data to train their underlying ML models. An open question in this field relates to building a text ranking pipeline that can perform well without using any human relevance judgments.

In the current IR paradigm, a reranker typically takes a query-passage pair as input and outputs a relevancy score, as in pointwise reranking. In a similar process, a pairwise reranker assesses the relative relevance between a pair of passages. In either process, the individual passages or passage pairs are processed independently without the information or context of the remaining passages in the candidate set. Existing approaches relating to supervised rerankers tackle this issue in the training process by updating the underlying ML models, based on pairwise or listwise loss (for example, through contrastive learning), which is computed from a pair or a list of candidate passages for the same query. Doing so forces the models to learn the relative relevance between the passages. However, given the need for human relevance judgments, such options can be time-consuming and expensive. Such options may also be unavailable due to issues such as barriers to data collection, data governance, or data rights.

Another disadvantage is that ML models, particularly generative models such as LLMs, are prone to hallucination, which refers to the generation of output that is factually incorrect or incoherent with respect to the input data or context. Some IR systems use an ML model, such as an LLM, as a final processing stage to integrate and generate (or synthesize) information retrieved by the earlier stage(s) in the data pipeline. In such an IR system, the inclusion of a reranker in the data pipeline reduces the risk that the downstream ML model will hallucinate. The reranker itself, however, when using an ML model (such as an LLM) is also prone to hallucination, inconsistency (since the ML model output can be non-deterministic) and positional bias (in some cases due to the underlying attention mechanism in the ML model).

Accordingly, there is a need for an improved system and method for reranking using an ML model, particularly an LLM, that obviates or mitigates at least some of the disadvantages or limitations of existing systems and methods.

This background information is provided to reveal information believed by the applicant to be of possible relevance to the present disclosure. No admission is necessarily intended, nor should be construed, that any of the preceding information constitutes prior art against the present disclosure.

### SUMMARY

A method of ranking digital information in an application is provided. The method includes executing via a computer system comprising at least one processor: receiving input data including an object of interest and a set of candidate items; processing, by a machine learning model, the input data based on a contextual understanding of the input data; generating output data based on the processing, wherein the output data includes candidate items ranked according to relevance to the object of interest; and applying the output data as ranked information in the application.

In an embodiment, the machine learning model is a language model.

In an embodiment, the object of interest is a query.

In an embodiment, the application is a natural language understanding task.

In an embodiment, the natural language understanding task is at least one of: search, question answering, fact verification, entity linking, content recommendation, and classification.

In an embodiment, processing the input data uses partition-based ranking.

In an embodiment, the method further includes repeating the method using at least one randomized variation of the set of candidate items to generate at least one additional output data.

In an embodiment, the method further includes aggregating the output data and the at least one additional output data to obtain an averaged output data.

In an embodiment, the method further includes receiving a critique request to generate a critique of the output data.

In an embodiment, the method further includes receiving a revision request to generate revised output data based on the critique of the output data.

In an embodiment, the input data further includes example data to refine the processing.

A device is provided. The device includes a network interface; a processor; and a non-transitory memory having stored thereon computer-executable instructions which, when executed by the processor, configure the device to: receive input data, including an object of interest and a set of candidate items; process, by a machine learning model, the input data based on a contextual understanding of the input data; and generate output data based on the processing, wherein the output data includes candidate items ranked according to relevance to the object of interest.

In an embodiment, processing the input data is repeatedly performed on a shifting subset of the set of candidate items.

In an embodiment, the device is further configured to repeat the receive, process, and generate steps using at least one randomized variation of the set of candidate items to generate at least one additional output data.

In an embodiment, the device is further configured to aggregate the output data and the at least one additional output data to obtain an averaged output data.

In an embodiment, the device is further configured to receive a critique request to generate a critique of the output data.

In an embodiment, the device is further configured to receive a revision request to generate revised output data based on the critique of the output data.

A system is provided. The system includes a data storage device for storing a candidate item database; a processor in communication with the data storage device, the processor configured to execute a candidate item retriever; and a candidate item reranker. The candidate item retriever is configured to: receive request data including an object of interest and a request for a set of candidate items; retrieve the set of candidate items from the candidate item database; and provide input data to a candidate item reranker, wherein the input data includes the object of interest and the set of candidate items. The candidate item reranker is configured to: receive the input data from the candidate item retriever; process, by a machine learning model, the input data based on a contextual understanding of the input data; and generate output data based on the processing, wherein the output data includes candidate items reranked according to relevance to the object of interest.

In an embodiment, processing the input data is repeatedly performed on a shifting subset of the set of candidate items.

In an embodiment, the candidate item reranker is further configured to repeat the receive, process, and generate operations using at least one randomized variation of the set of candidate items to generate at least one additional output data.

In an embodiment, the candidate item reranker is further configured to aggregate the output data and the at least one additional output data to obtain an averaged output data.

In an embodiment, the candidate item reranker is further configured to receive a critique request to generate a critique of the output data.

In an embodiment, the candidate item reranker is further configured to receive a revision request to generate revised output data based on the critique of the output data.

In an embodiment, the input data further includes example data to refine the processing.

Embodiments have been described above in conjunction with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art. Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a flowchart of a method of ranking a set of candidate items using an ML model such as an LLM, according to an embodiment;

FIG. 2 is a flowchart of a method of ranking without task-specific training data, according to an embodiment;

FIG. 3 is a schematic diagram of a system based on the method of FIG. 2, according to an embodiment;

FIG. 4 is a flowchart of a method of overcoming input length limitations, according to an embodiment;

FIG. 5 is a schematic diagram of a system based on the method of FIG. 4, according to an embodiment;

FIG. 6 is a flowchart of a method of overcoming positional bias, according to an embodiment;

FIG. 7 is a schematic diagram of a system based on the method of FIG. 6, according to an embodiment;

FIG. 8 is a flowchart of a method of overcoming insufficient adherence to instructions, according to an embodiment;

FIG. 9 is a schematic diagram of a system based on the method of FIG. 8, according to an embodiment;

FIG. 10 is block diagram of an electronic device, according to an embodiment;

FIG. 11 is a schematic diagram of a system based on the method of FIG. 1, according to an embodiment;

FIG. 12 is a schematic diagram of a network system based on FIGS. 1, 10 and 11, according to an embodiment;

FIG. 13 is a table depicting results of three TREC Deep Learning (DL) datasets, according to an embodiment; and

FIG. 14 is a table depicting results of three MIRACL datasets, according to an embodiment.

It will be noted that throughout the appended drawings, like features are identified by like reference numerals.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more computer systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level programming language, such as functional, declarative, concurrent, logic, event-driven, procedural, object-oriented programming, and/or scripting language to communicate with the one or more computer systems. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present disclosure.

Those skilled in the art will recognize the tendency in the IR field to refer to the input and output of an IR system as “query” and “documents”, respectively, even when the precise nature of the input and output is not, strictly speaking, a query or a list of documents. Indeed, the precise nature of the object of interest and candidate items depends on the NLU application.

The present disclosure aims to remove this ambiguity by referring to the user-provided input as an objective of interest and the system output as a list of candidate items. For additional clarity on this point, the present disclosure briefly describes several NLU applications of an IR system below, in terms of their specific kinds of input and output. These descriptions will also demonstrate the broad applicability of an IR system, beyond querying documents (in the strictest sense).

Someone skilled in the art will recognize that a user can be a human user or a proxy for a human user, such as a computing function or a software agent within a larger software system.

Although the typical criteria for ranking candidate items is relevance, some NLU applications involve different or additional criteria, such as suitability, veracity, etc. Such criteria, when complex, may also be expressed as rules (e.g. as in preferential ranking or to accommodate exceptions). Also, some NLU applications require an additional, final processing stage that evaluates or summarizes the response.

For instance, a search application involves retrieving and reranking document(s) with respect to a query, using the criteria of relevance. A query is a user-provided request for information. A document can be a full text document, text passage, text fragment or text snippet, including a web page or other text content in digital form.

A question answering application involves retrieving and reranking the most relevant answer(s) with respect to a given question. Instead of simply returning the top-ranked answer(s), however, an optional, final stage may select and summarize the best answer from a top-ranked set of candidate items from the reranked list. These candidate items may be complete answers in their own right or may be parts of an answer that span multiple candidates items. The latter case requires the synthesis of a single answer for the user, as an additional post-processing step.

A fact verification application involves retrieving and reranking the most relevant evidence with respect to a given fact. Here, an additional stage in the pipeline may generate, from the top-ranked pieces of evidence, an overall conclusion about the veracity of the user-provided fact. For example, the fact verification system may provide the user with a verification status (e.g. Verified, Disputed, or False) based on the ranking results, with an optional explanation. Example user input: “Does Vitamin C prevent colds?” Example system answer: “Disputed. No conclusive evidence that Vitamin C prevents colds.”

A content recommendation application involves retrieving and reranking content items with respect to a given content item. A content item could be a document, a user profile, a text message, a social media post, an image caption, or any kind of textual item specific to the use case. For example, in ecommerce, the content item could be a product title and its accompanying product description for a particular stock keeping unit (SKU). In some cases, the ranking criteria depends on the task at hand. For instance, in a cross-selling scenario, the ranking criteria may be how well the content items (e.g. product titles and descriptions of various dress shoes from a product inventory) complement the user-provided content item (e.g. a description of a suit the user plans to wear at a wedding). In other scenarios (e.g. “more items like this”) the criteria may be content item similarity.

An entity linking application involves retrieving and reranking the most relevant entity descriptions with respect to a given mention (which has normally been extracted from some piece of text). Someone skilled in the art will recognize the entity linking task as similar to the word sense disambiguation task, where the best-matching word senses are reranked with respect to a given word or phrase. In both cases, a preprocessing stage will have extracted the mentions, words or phrases from a user-provided content item.

As used herein, the following terms will be understood to have the following meanings.

Answer: The response to a user in a question answering system. For example, a system answer could be “The capital of France is Paris.” The corresponding user question might have been “What is the capital of France?”

Candidate: An informational element being considered for ranking, such as a candidate document or text passage. A set of candidates may be called the candidate items or candidate set.

Chain: See Prompt chain.

Context window: Maximum span of text considered by a process, such as a machine learning model, including an LLM, or some other natural language process.

Data pipeline: In the context of an IR system, a sequence of operations for processing user input, retrieving relevant information from a dataset, reranking the retrieved information and postprocessing the ranked result. Here, we are using the term, data pipeline, in a general sense, and may include any process or set of processes that move data from one computer system to another. Examples of these variants include data streaming platforms, data integration tools, cloud data services, data mesh or event-driven architectures.

Document: The text or information being retrieved and ranked, including a text passage, text snippet, text fragment, text description, label, etc.

Fact verification: Automated process to validate factual statements against trusted sources.

Few-shot prompting: Guiding the ML, LLM, or NLU task with a small number of examples to influence the response. Contrast with zero-shot prompting (below).

Grounding: Crafting inputs to guide ML and LLM models (that is, through prompt engineering), to anchor the LLM response to external knowledge or data sources for context accuracy.

IR (information retrieval): Processes and technologies for finding relevant information and data in response to a query. Popularly, the user-driven process of applied IR is referred to as search.

Instruction: A directive or command given a computer system, such as an ML model, to perform a specific task.

LLM (Large Language Model): A type of deep learning model that is pretrained on diverse datasets.

LRL: A listwise reranker using an ML model, such as a language language model.

Listwise ranking: Evaluates and ranks an entire list of items (answers) as a whole, based on the items' collective relevance (within the list) to a query or question.

Contrast with pairwise and pointwise ranking below.

Object of interest: A specific subject, item, or entity that is the focus of a given context. Objects of interest are often used as inputs, such as a user's query or document.

Passage: Sometimes called a text passage, candidate or document. Can alternatively be a label or snippet. In the context of LRL, it refers to an item in the list being ranked by the LLM.

Pairwise ranking: A common approach to ranking a set of documents or textual candidate items, where two candidate documents or other textual items from the set are assessed as a pair, relative to each other and with respect to a query or other object of interest, based on one or more criteria (such as relevance). A subsequent step compares all possible pairs of documents and then aggregates these comparisons to construct an overall ranked list. Contrast with listwise ranking above and pointwise ranking below.

Pointwise ranking: A common approach to ranking a set of documents or textual candidate items by evaluating and scoring each item independently, with respect to a query or other object of interest, based on one or more criteria (such as relevance).

Contrast with listwise and pairwise ranking above.

Prompt: Input text given to an LLM to generate a response.

Prompt chain: Series of related prompts and responses to achieve complex tasks or output refinement.

Query: In the field of information retrieval, the term “query” is often a generalization for an input, usually a textual input.

Relevance: An evaluation of candidate items ranked according to one or more ranking criteria with respect to an object of interest.

Reranker: A system or process that adjusts or evaluates the order of a previously ranked list of items such as documents, as (for example) in the second component of a two-stage IR architecture. In some contexts, a reranker may be called a ranker when the first stage is called a retriever. See retriever.

Retriever: A system or process that retrieves or generates a set or subset of documents from a larger corpus or dataset, as (for example) in the first component in a two-stage IR architecture. In some contexts, a retriever may be called a ranker when the second stage is called a reranker. See reranker.

Question: The user-provided question to a question answering system. A user question could be “What is the capital of France?” (The system answer could be “The capital of France is Paris.”)

Question answering: The task of retrieving and providing answers to user-posed questions in natural language. A question answering system achieves this task.

Rank aggregation: A process that combines multiple ranking lists into a single, consolidated order based on one or more criteria or rules. The process is conceptually analogous to finding an average rank, where the final position of each item reflects a composite assessment from all lists, although the specific method may not directly calculate an average rank.

Text: Refers to a sequence or words or characters. As used herein, the text is understood more broadly as encoded information or knowledge that may be derived from processing, interpreting, or understanding text. The term “text passage” can also refer to broader meanings of text. Those skilled in the art will recognize that there are many methods and technologies available to derive text.

Text ranking pipeline: A specific type of data pipeline for ranking information.

Token: Basic unit of text analysis; often a word or part of a word. In terms of text ranking, a token can be the characters indicating the beginning and end of the list (e.g. square brackets), the characters that delimit the items in the list (e.g. commas), and the text passages or identifiers themselves. A given passage or identifier may consist of one or more tokens. For example, an LLM might generate the string “[Passage1, Passage2]” from a sequence of 10 tokens: sequence “[”, “,”, “Pass”, “age”, “1”, “,”, “Pass”, “age”, “2”, “]”.

Zero-shot prompting: Providing a ML, LLM, or NLU task without example inputs or outputs; the LLM infers solely from information in the prompt and from its intrinsic knowledge. Contrast with few-shot prompting (above).

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to ML, and more particularly to techniques for passage reranking with an LLM. Where specific embodiments discuss the use of an LLM, those skilled in the art will understand this to apply to the use of ML models generally, or any component developed to provide an analogous function.

Current state-of-the-art supervised reranking methods require task-specific training data. However, task-specific training data involves collecting human relevance judgments, which is time-consuming, expensive, and not always available.

Pointwise rerankers typically take a query-passage pair as input and output a relevancy score, but the passages are processed independently of each other. In a similar process, pairwise rerankers assess the relative relevance between a pair of passages. In either process, the individual passages or passage pairs are processed independently without the information or context of the remaining passages in the candidate set. Existing approaches relating to supervised rerankers tackle this issue in the training process, causing the underlying models to learn the relative relevance between the passages.

Zero-shot prompting refers to providing a task without any example inputs or outputs, in which case the LLM infers solely from the context of the prompt and its intrinsic knowledge. Zero-shot rerankers do not have any task-specific training, and therefore cannot take advantage of techniques relating to task-specific training. However, it is possible to take advantage of an LLM's ability to perform well at reranking without requiring any human relevance judgments.

Given a query q and candidate documents {D₁, . . . , Dₖ} from a previous ranking stage, a pointwise reranker (e.g., UPR) takes a query q and a single document Dᵢ at a time and outputs a score for the (q, Dᵢ) pair, indicating the query-document relevance. The documents are then ranked according to their scores. This paradigm is held even when the reranker is based on sequence-to-sequence (seq-to-seq) models. Taking monoT5 as an example, although it is based on the seq-to-seq T5 backbone and asks the model to generate True/False tokens as output, it is ultimately optimized on the logits of the two tokens as a classification task, and outputs a score for each query-document pair.

Embodiments of the present disclosure describe a zero-shot LRL. Specifically, an LLM (such as, GPT-3.5 or GPT-4) may be instructed as a zero-shot listwise reranker that takes a query and a list of candidate passages as input and directly generates a re-ordered list of the passage identifiers based on the relevancy of the passages to the query. By taking multiple passages into account, a zero-shot listwise reranker is more effective than a pointwise one.

More specifically, LRL takes in a query q and a list of documents {D₁, . . . , Dₘ} as input and returns a reordered list of the input documents. The key difference is that LRL considers information from multiple documents simultaneously while performing ranking. In the context of Transformer-based models, this means the model could attend across candidate passages to determine their relative ranking position. Moreover, the listwise reranker directly outputs an ordered document list, which forms a “seq-to-seq” process and naturally adapts to ML models such as LLMs.

Unlike state-of-the-art supervised ranking methods, using an LLM to rank text passages does not require task-specific training data, since LLMs offer strong zero-shot performance for many tasks, including text ranking. As such, they do not need any task-specific examples at inference time. In some scenarios, a few examples may be helpful, which those skilled in the art would recognize as few-shot prompting.

In listwise ranking, multiple candidate items (such as passages) are processed at once, rather than independently as query-passage pairs. Operationally, this is more efficient than pointwise reranking, since it avoids the overhead of splitting the list into query-passage pairs and aggregating them after scoring, as well as repeating the same instructions for each pair. Also, the quality of the listwise-generated ranking result benefits from the presence of the other passages in the list, which provides additional context to the LLM.

A simple instruction template is used to prompt the LLM to perform the zero-shot listwise ranking:

Passage1 = {passage_1}
...
Passage10 = {passage_10}
Query = {query}
Passages = [Passage1, ..., Passage10]
Sort the Passages by their relevance to the Query.
Sorted Passages = [

Those skilled in the art will recognize that many variations of this prompt template are possible, including variations that use different wording in the instructions or specify criteria other than relevance for ordering the passages.

Candidate passages are listed on each line and followed by the target query and an instruction. The square bracket at the end is left unclosed intentionally, to encourage the model to complete the Sorted Passages with a list of passage IDs, where the first item is expected to be the most relevant.

For a fair comparison of listwise and pointwise reranking, a variant of a prompt for zero-shot pointwise reranking may be used. The model is instructed to make relevant judgments for a query-passage pair:

Passage: {passage}
Query: {query}
Is this passage relevant to the query?
Please answer True/False.
Answer:

This makes the probability distribution of the first decoded token gathered on token True and False, hence the probability of decoding token True is used as the relevance score. This baseline is denoted as PRL (Pointwise Reranker with LLM).

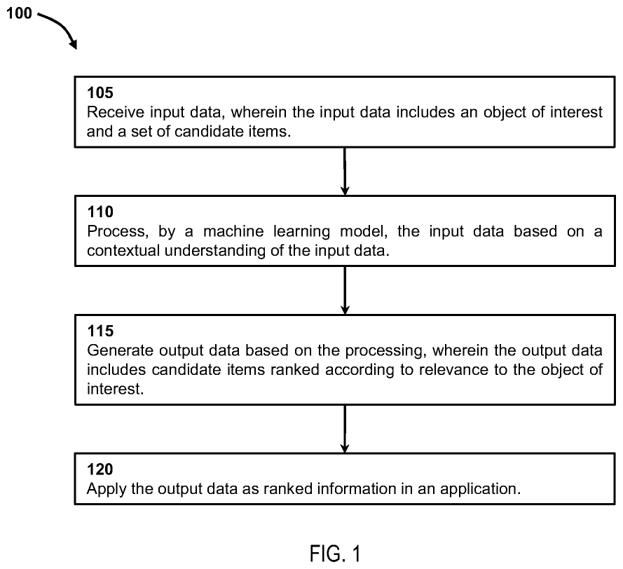

Referring now to FIG. 1, shown therein is a method 100 at an ML model such as an LLM, according to an embodiment. The method 100 may be encoded as computer-executable instructions which, when executed by one or more processors, cause the computer to perform the method.

At 105, the method 100 includes receiving input data, wherein the input data includes an object of interest and a set of candidate items.

In some embodiments, the input data includes a prompt.

In some embodiments, the object of interest is a query or a question, while in other embodiments the object of interest includes a broader meaning.

In some embodiments, the candidate items include passages, while in other embodiments the candidate items could refer to broader meanings of text.

In some embodiments, candidate items could come directly from a user, or a user proxy such as a software agent or another software component or software system.

In some embodiments, the method 100 is performed as a second stage (or intermediate) ranker (also known as a reranker) within a two-stage ranking paradigm. Therefore, in some embodiments, the candidate items are first stage retrieval results for the given query.

In some embodiments, the candidate items could be the results of an earlier reranking stage that was not the first stage, such that LRL acts as a last-stage reranker in a multi-stage IR pipeline.

It will be appreciated by those of skill in the art that candidate items could be text in English or in one or more non-English languages.

At 110, the method 100 further includes processing the input data based on a contextual understanding of the input data.

While any state-of-the-art LLM will likely perform well, the exact choice will depend on cost, the effectiveness of the model at the task, and the desired accuracy. For example, state-of-the-art LLMs may over-tokenize non-English languages, therefore a model that better supports longer input lengths may be more appropriate.

At 115, the method 100 further includes generating output data based on the processing, wherein the output data includes candidate items ranked according to relevance to the object of interest.

In some embodiments, input data may be structured in a manner such that the LLM directly generates a list of candidate item identifiers, rather than an ordered list of the candidate items themselves.

In some embodiments, the output data includes candidate items ranked according to criteria other than relevance. In some embodiments, a processor or transformation in the data pipeline, possibly acting as an output parser, extracts the reranked list into a machine-readable data structure (such as a list of strings) for further processing.

For example, “[Passage1, Passage2, Passage3, . . . ]” (a single string of text) may be transformed into [“Passage1”, “Passage2”, “Passage3”, . . . ], which may be, for example, a list of strings in a programming language. In some embodiments, another processor or transformation in the data pipeline maps the reranked list of identifiers to corresponding text passages.

For example, [“Passage1”, “Passage2” ] may be mapped to [“The San Francisco 49ers won their last Super Bowl in the 1994 season.”, “The 49ers won their most recent Superbowl in the 1990s.” ]

At 120, the method 100 further includes applying the output data as ranked information in an application.

Unlike state-of-the-art supervised ranking methods, using an LLM to rank text passages does not require task-specific training data. Task-specific training data involves collecting human relevance judgments, which is time-consuming and expensive. LLMs offer strong zero-shot performance for many tasks, including text ranking. They do not need any task-specific examples at inference time, although a few examples may help in some scenarios, which would then be few-shot learning.

In an LRL, multiple passages are able to be processed at once, rather than independently as query-passage pairs. Operationally, this is more efficient than pointwise reranking, since it avoids the overhead of splitting the list into query-passage pairs and aggregating them after scoring, as well as repeating the same instructions for each pair. Also, the quality of the listwise-generated ranking result benefits from the presence of the other passages in the list, which provides additional context to the LLM.

An immediate application of techniques disclosed herein is question answering. In a question answering system, an LRL may be used to provide the top-ranked passage as the answer to a user-provided question. An LRL may similarly be used to generate a summary of a set of top-ranked passages, and to then return the generated summary to the user as a single answer. In all cases, where any original passages have a source, then the sources could also be included in the response to the user as one or more citations.

Another application of techniques disclosed herein is fact verification. In an automated process to validate factual statements against trusted sources, an LRL may be employed to power a fact verification system. As a ranker, an LRL could search for evidence and consensus among retrieved passages from a trusted data source. As a final step, the fact verification system may provide the user with a verification status (for example, verified, disputed, or false) based on the ranking results.

A further application of LRL is classification. In a single-label classification use case, where the text passages are candidate categories, LRL may be used to provide the top-ranked passage as the predicted category (or class) for the given item (query). In a multi-label classification use case, LRL may be used to provide the top categories above some predetermined threshold. Another approach to classification could involve ranking descriptions of indexed exemplar items and then using the top-ranked exemplar category as the predicted category for the user-provided item.

In another application, LRL could also be applied to rank candidates in word-sense disambiguation and entity linking tasks.

In some embodiments, processing the input data is repeatedly performed on a shifting subset of the set of candidate items. Due to the constraint of runtime and memory cost, Transformer-based models enforce input length limitations. For example, GPT-3 limits the maximum input length to 4,000 tokens. In some cases, the listwise reranker disclosed herein may be tasked with reranking a list of documents that is longer than the number of documents that the model can handle. To solve this issue, a sliding window (or shifting subset) strategy is provided.

Concretely, assuming that the model is able to rerank m candidate items (for example, passages) at a time, in order to rank a list with length n>m, the reranking is started with the last m passages from the list. This step can be simplified by choosing a conservative value for m (one that allows for a query or instruction as additional text in the prompt). By truncating overly long passages, it can also be possible to ensure that the size of the passage list does not exceed the limit. In some embodiments, it may also be necessary to truncate individual passages. Next, the ranking window is shifted towards the head of the list by m/2 and reranked. This operation is repeated until the window reaches the head of the list. Ideally, this strategy should be able to carry m/2 most relevant documents to the head of the list in one round. It should be appreciated however that while this strategy is not able to completely reorder an entire list, it has been demonstrated as an effective technique to improve top-ranking results.

In some embodiments, an elimination-style type of structure may be used to rank or rerank a list. Similar to the sliding window approach described above, reranking may be performed between candidate item pairs to eliminate a candidate item each time until a desired size of reranked candidate items is achieved. In some embodiments, different pairs of candidate items may be reranked in parallel.

In some embodiments, the method 100 further includes repeating the method using at least one randomized variation of the set of candidate items to generate at least one additional output data.

In some embodiments, different randomized or shuffled variations of a set of candidate items may be reranked in parallel. The number of permutations may vary, and may be, for example, 5, 10, 20, or some other empirically determined value).

In some embodiments, the set of candidate items may be shuffled by uniformly random shuffling, while in other embodiments it may be shuffled by weighted random shuffling, or another form of shuffling or randomization.

In some embodiments, the method 100 further includes aggregating and averaging the output data and the at least one additional output data to obtain an averaged output data. In some embodiments, aggregating the rankings into a single ranking is performed using a conventional rank aggregation technique, such as Borda count or Kameny-Young using Kendall tau distance.

In some embodiments, the method 100 further includes receiving a critique request to generate a critique of the output data. In some cases, an LLM will return an answer or result that potentially does not follow the intended ranking criteria and/or formatting criteria. This problem may be addressed by using a self-critiquing chain to improve adherence to instructions, whereby a critique request (prompt) is provided to the LLM. Such a prompt instructs the LLM to critique the generated, listwise ranking.

In some embodiments, the criteria for critiquing are implicit and no additional instructions to the ML model or LLM are necessary.

In some embodiments, the prompt can incorporate explicit, user-defined criteria or rules for critiquing the output. Similarly, the generated list may be critiqued directly as well. Such self-critiquing steps could occur prior to the parsing of generated output. In some embodiments, the object being critiqued may be a derived result from the reranked list, such as the top result, after it has been mapped to a category (e.g. in a classification task).

In some embodiments, the ML model or LLM being used may be fine-tuned for the critiquing task.

In some embodiments, the method 100 further includes receiving a revision request to generate revised output data based on the critique of the output data. This may include devising a prompt or other input that instructs the ML model or LLM to revise a generated result, given a generated critique.

In some embodiments, this may further include providing specific revision criteria.

In some embodiments, the ML model or LLM being used may be fine-tuned for the revision task.

Advantages achieved by critiquing and revising are immediately recognizable in that final results are much more likely to respect the user-intended instructions.

In some embodiments, the input data further includes example data to refine the processing. Providing some examples in the prompt or other input (thereby converting the zero-shot system to a few-shot system) may be used to clarify the ranking criteria as well as the expected output format.

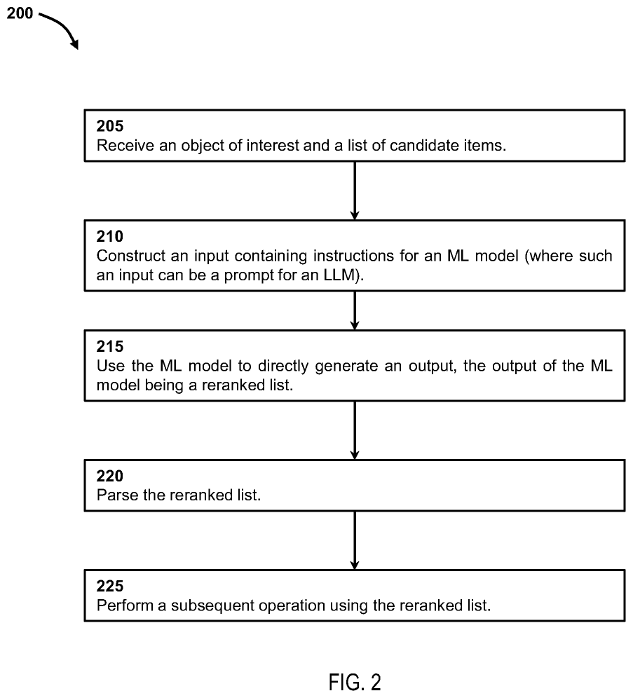

Referring now to FIG. 2, shown therein is a flowchart of a method 200 of ranking without task-specific training data, according to an embodiment. The method 200 may be encoded as computer-executable instructions which, when executed by one or more processors, cause the computer to perform the method.

At 205, the method 200 includes receiving an object of interest and a list of candidate items.

In some embodiments, the LRL acts as a second-stage reranker (sometimes called a ranker) within a conventional, two-stage IR pipeline. The candidate items are first-stage retrieval results for the given object of interest. The first-stage retriever could be any fast, state-of-the-art retriever, such as BM25. The nature of the candidate items depends on the application.

In some embodiments, the candidate items include passages, while in other embodiments the candidate items could refer to broader meanings of text.

In some embodiments, the candidate items could come directly from a user, or from a user proxy. Alternatively, the candidate items could be the results of an earlier ranking stage that was not the first stage, such that the LRL acts as a last-stage reranker in a multi-stage IR pipeline.

In some embodiments, the candidate items are text passages in English, while in other embodiments, the candidate items could be text in one or more non-English languages.

At 205, the method 200 further includes constructing a prompt for an ML model such as a large language model (LLM).

In some embodiments, this includes a user-provided query in the prompt, alongside the list of candidate items, which could be text passages. To reduce the number of output tokens, the prompt may be structured in such a way that the LLM directly generates a list of passage identifiers, rather than an ordered list of the passages themselves. In some embodiments, the prompt may be instructed to rank the passages in terms of their relevance to the given query.

In some embodiments, where the list of candidates is short and/or indeed the passages themselves are short (e.g. simple labels), then only the passages are provided (i.e. no need for identifiers). In some embodiments, the prompt is instructed to rank the passages in terms of criteria other than relevance.

In some embodiments, no examples are provided (zero-shot). In some embodiments a few examples are provided (few-shot) to clarify the ranking criteria as well as the expected output format.

At 205, the method 200 further includes using the LLM to directly generate an output, the output of the LLM being a reranked list.

In some embodiments, any state-of-the-art LLM is used for this. The exact choice will depend on the tradeoff between cost, the effectiveness of the model at the task, and the user's accuracy needs for a particular use case. For instance, state-of-the-art LLMs may over-tokenize non-English languages. Therefore, for non-English text, consider a model that supports longer input lengths (such as older or discounted LLMs).

At 205, the method 200 further includes parsing the reranked list.

As is conventional with LLMs, the output is a single text string, resulting from the concatenation of a series of generated string tokens. The concatenated text is effectively a string representation of the reranked list of passages. Provided the LLM has followed the user-provided instructions, the precise formatting of the list reflects what those instructions specified.

A processor or transformation in the data pipeline (acting as an output parser) extracts the reranked list into a machine-readable data structure (such as a list of strings) for further processing. For example, “[Passage1, Passage2]” would be transformed into [“Passage1”, “Passage2” ], which someone skilled in the art would recognize as a list of strings in a programming language like Python.

Another processor or transformation in the data pipeline then maps the reranked list of identifiers to their corresponding text passages. For example, [“Passage1”, “Passage2” ] would be mapped to [“The San Francisco 49ers won their last Super Bowl in the 1994 season.”, “The 49ers won their most recent Superbowl in the 1990s.” ]

In some embodiments, if passage identifiers were not used, then no mapping transformation is needed. Instead, the items in the list can be parsed directly from the LLM output.

At 205, the method 200 further includes performing a subsequent operation using the reranked list.

In some embodiments, a question-answering system may be implemented. In a question-answering system or use case, provide the top-ranked passage as the answer to the user-provided question. As a variation, the system could be used to summarize a set of multiple, top-ranked passages using an LLM, returning a generated summary to the user as a single answer.

In all cases, if the original passage has a source (or passages have sources), then the source(s) can be included in the response to the user as one or more citations.

In some embodiments, fact verification may be conducted. In an automated process to validate factual statements against trusted sources, LRL may be employed to power a fact verification system. As a ranker, an LRL could search for evidence and consensus among retrieved passages from a trusted data source. As a final step, the fact verification system may provide the user with a verification status (for example, verified, disputed, or false) based on the ranking results.

In some embodiments, LRL could be used in classification. In a single-label classification use case, where the text passages are candidate categories, LRL may be used to provide the top-ranked passage as the predicted category (or class) for the given item (query). In a multi-label classification use case, LRL may be used to provide the top categories above some predetermined threshold. Another approach to classification could involve ranking descriptions of indexed exemplar items and then using the top-ranked exemplar category as the predicted category for the user-provided item. LRL could also be applied to rank candidates in word-sense disambiguation and entity linking tasks.

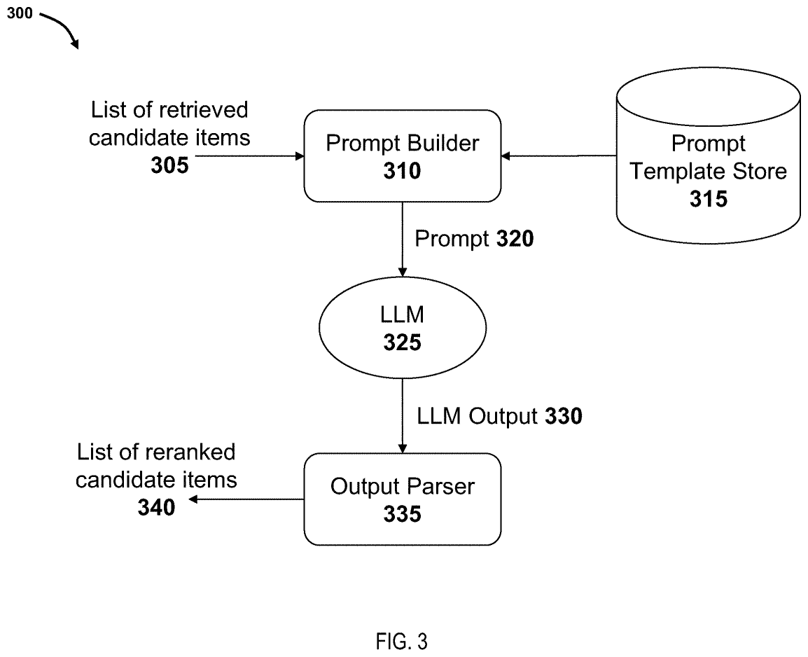

Referring now to FIG. 3, shown therein is a schematic diagram of a system 300 based on the method 200 of FIG. 2, according to an embodiment.

In the system 300, a list of retrieved candidate items 305 is provided to a prompt builder 310. The prompt builder 310 obtains a prompt 320 from a prompt template store 315. The prompt builder 310 provides the prompt 320 to an LLM 325, which ranks the prompt 320 and outputs an LLM output 330 to an output parser 335. The output parser 335 parses the LLM output 330 to generate a list of reranked candidate items 340.

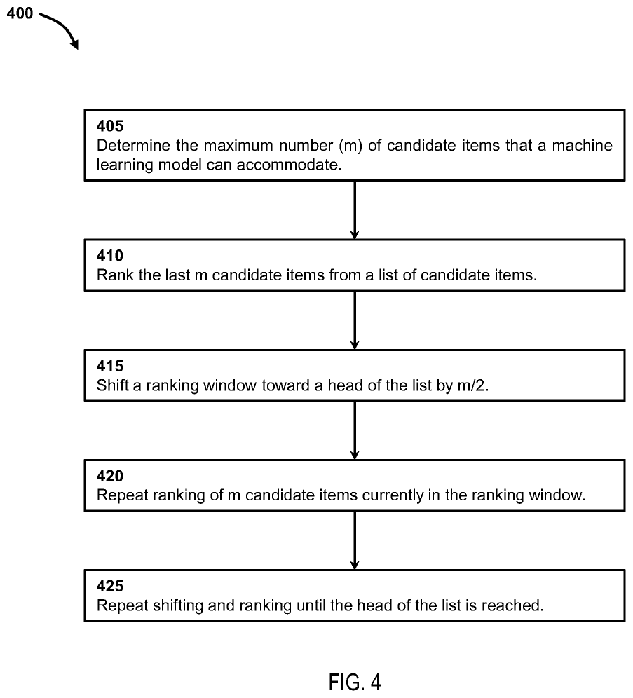

Referring now to FIG. 4, shown therein is a flowchart of a method 400 of overcoming input length limitations, according to an embodiment. The method 400 may be encoded as computer-executable instructions which, when executed by one or more processors, cause the computer to perform the method.

The attention mechanism in an LLM imposes a constraint on how much text input the LLM can process. The list of passages for ranking may exceed this limitation. Any method of partition-based ranking, such as progressive ranking, can be used to address the problem of input length limitations. In this context, “partition” refers to a subset list of candidate items contained within the larger, complete list of candidate items.

At 405, the method 400 includes determining the maximum number (m) of candidate items that a large language model (LLM) can accommodate.

In some embodiments, this step may be greatly simplified by choosing a conservative value for m (one that allows for a query or instruction as additional text in the prompt). Truncating overly long candidate items can also ensure that the size of the candidate item list does not exceed the limit. In some variations, it may also be required to truncate, summarize, or otherwise shorten individual candidate items.

In some embodiments, the maximum number of candidate items depends on a second quantity: the length of the question or instructions (possibly including ranking criteria or grounding information, provided by the user or system at runtime). Therefore, token length of the criteria will impact how many candidate items can be included within a single prompt. In some variations, the size of the criteria may change dynamically. Indeed, the candidate items themselves can have varying lengths. A processor is therefore needed that determines (or possibly approximates) how much room is left in the prompt for the instruction of fixed size, the query and the list of candidate items.

At 410, the method 400 further includes ranking the last m candidate items from a list of candidate items.

In some embodiments, this is injecting only the last m candidate items into the prompt, instead of all n candidate items. As an example: A total of 100 candidate items to be ranked using an LRL, with a ranking window of 20 candidate items. In the first iteration, LRL will rank candidate items 81 to 100.

At 415, the method 400 further includes shifting a ranking window toward a head of the list by m/2.

In continuing the example of 100 candidate items, shifting the ranking window toward the head of the list by 10 candidate items means the window now contains candidate items 71 to 90. As such, the first half of the current ranking window contains 10 unranked candidate items followed by the top-10 candidate items from the previous window. Notably, the bottom half of the ranked, previous window will remain in its bottom half (in that same order) throughout the rest of the progressive ranking process. It should be noted that in this context “unranked” means unranked by an LRL. In a two-stage IR architecture, all 100 candidate items have already undergone an initial (less effective) ranking by the fast, first-stage retriever.

In some embodiments, when calculating the size of the window shift, the choice of the denominator is somewhat arbitrary. Progressive ranking is an approximate ranking method. A particular use case may be more concerned or less concerned about the impact of this approximation. If there is less concern, shifting the window by an amount more than half the number of candidate items (e.g. 3*m/4) has the benefit of increasing efficiency. For example, shift by 15 instead of 10. If there is more concern, shift the window by an amount less than half the number of candidate items (e.g. m/4). As an example, shift by 5 instead of 10.

At 420, the method 400 further includes repeating ranking of m candidate items currently in the ranking window.

In some embodiments, this is the same as step 410 but instead using the m candidate items in the current window (after shifting in step 415). This culminates two iterations.

At 425, the method further includes repeating shifting and ranking until the head of the list is reached.

As an example: the third iteration would rank candidate items 61 to 80, the fourth would rank candidate items 51 to 70, the ninth would rank candidate items 11 to 20, and the tenth and final iteration would rank 1 to 10.

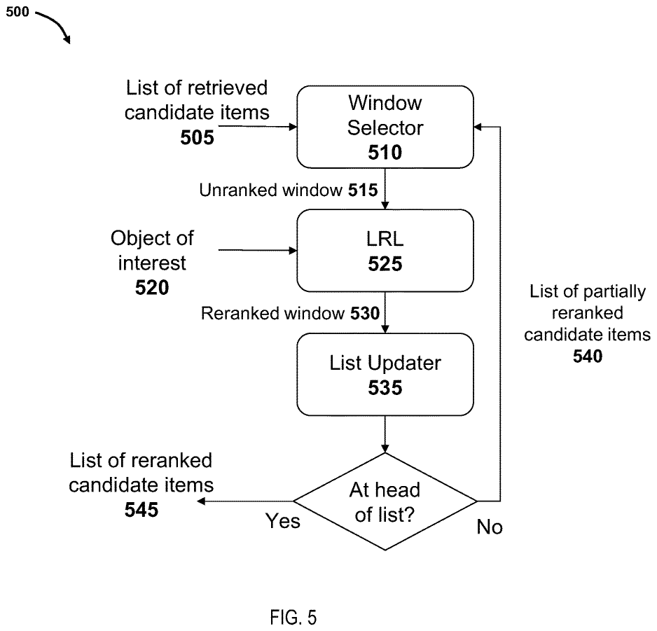

Referring now to FIG. 5, shown therein is a schematic diagram of a system 500 based on the method 400 of FIG. 4, according to an embodiment.

In the system 500, a list of retrieved candidate items 505 is provided to a window selector 510. The window selector 510 provides an unranked window 515 to an LRL 525, which ranks the unranked window 515 based on a provided query 520. The LRL 525 then outputs a ranked window 530 to a list updater 535. Then a check is performed to determine if the window is at the head of the list. If it is not, then the list of partially reranked candidate items 540 is provided to the window selector 510 again. If the head of the list has been reached, then a list of reranked candidate items 545 is output.

Ideally this strategy promotes the m/2 most relevant documents to the head of the list in one round. After reranking the passage IDs in a window, only the passage IDs in the top half of the window are included in the subsequent window (after sliding the window toward the head of the list). Therefore, the progressive ranking strategy is not able to completely reorder the entire list of candidates—it is an approximate method. It has been demonstrated however, that the method is still effective at improving the top-ranked results. If the fast, first-stage retrieval method is relatively effective at ranking, then concerns about approximate ranking in the second-stage ranker are mitigated.

In some embodiments, an alternative approach to partition-based ranking would be to combine the efficiency of listwise reranking of a sufficiently short list with the scalability of well-known sorting algorithms, especially algorithms such as mergesort or heapsort, which work well with pre-sorted or partially sorted data. Those skilled in the art will recognize that mergesort and heapsort have a chunking or partitioning step, followed by a local ranking step, followed by a merge step (heapsort also has heap creation step before the merge step). Within this well-known sequence of steps, a listwise reranker can operate on the chunked or partitioned set of candidate items during the local ranking step. Those skilled in the art will also appreciate that, when using an ML such as LLM, such a ranking approach may constitute a map-reduce prompt chain, where the map phase comprises the chunking and local ranking steps, while the reduce phase comprises the merging step.

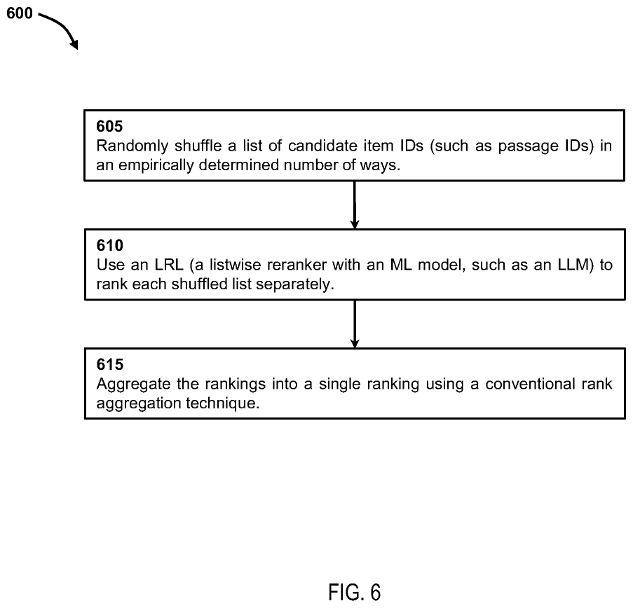

Referring now to FIG. 6, shown therein is a flowchart of a method 600 of overcoming positional bias, according to an embodiment. The method 600 may be encoded as computer-executable instructions which, when executed by one or more processors, cause the computer to perform the method.

Embodiments of the present disclosure provide for using an approach such as Permutation Self-Consistency (PSC) to mitigate the problems of positional bias and non-determinism. ML models, such as LLMs, can bias their attention away from the middle of an input, particularly a lengthy input that contains a list of candidate items. In the reranking stage of an IR system, this positional bias puts candidate items in the middle of the candidate list at risk of not being properly reranked by the ML model. For example, in a question answering system, such positional bias could result in the best answer(s) not appearing near the top of the reranked candidate list. ML models, including LLMs, can also yield non-deterministic output. Repeatability is beneficial, especially in IR systems, to promote reliability and user trust through consistent, predictable results for the same inputs.

At 605, the method 600 includes randomly shuffling a list of candidate item IDs, such as passage IDs, in an empirically determined number of ways.

In various embodiments, the number of permutations could be 5, 10, 20 (or some empirically determined number). Experimental results suggest somewhat diminishing returns after 5-10, with little meaningful improvement after 20.

At 610, the method 600 further includes using LRL to rank each shuffled list separately.

At 615, the method 600 further includes aggregating the rankings into a single ranking using a conventional rank aggregation technique.

In some embodiments, the list of passage IDs are uniformly random shuffled. In other embodiments, the passage IDs are weighted random shuffled.

A degenerate case to avoid would be one where all shuffled lists given to the LLM are essentially identical at the beginning and end of the list (i.e., they only differ at the middle of the list, where the LLM is potentially less attentive and therefore less effective at ranking).

In some embodiments, the shuffling is biased in a way that ensures increased variation in how passage IDs are ordered near the beginning and end of the list.

In some embodiments, after producing the lists (via weighted random shuffling) the variance at the top and bottom of the list is assessed. If the variance is below an experimentally established threshold, then the shuffling could be redone. This may be repeated until reshuffling achieves the desired variance or some maximum number of attempts is reached.

In some embodiments, as an optimization, weighted random shuffling with assessment may reduce the number of permutations needed, thereby reducing the cost of using PSC.

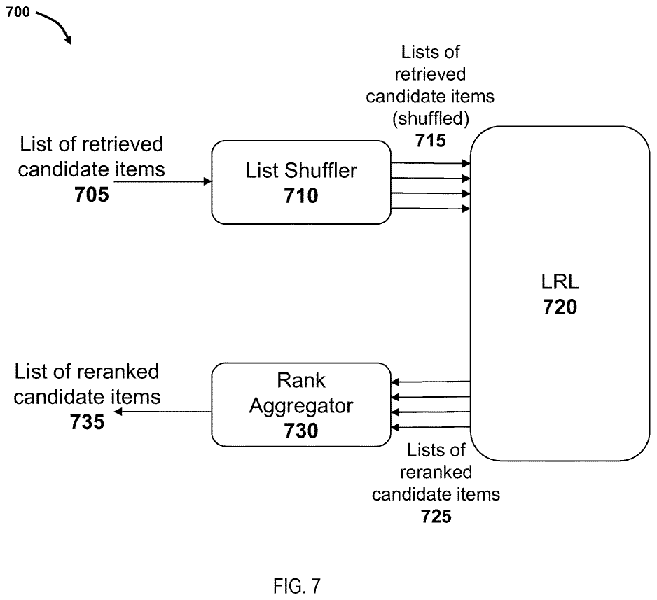

Referring now to FIG. 7, shown therein is a schematic diagram of a system 700 based on the method 600 of FIG. 6, according to an embodiment.

In the system 700, a list of retrieved candidate items 705 is provided to a list shuffler 710. The list shuffler 710 outputs shuffled lists of reranked candidate items 715 to a LRL 720. The LRL 720 outputs lists of reranked candidate items 725 to a rank aggregator 730. The rank aggregator 730 outputs a list of reranked candidate items 735.

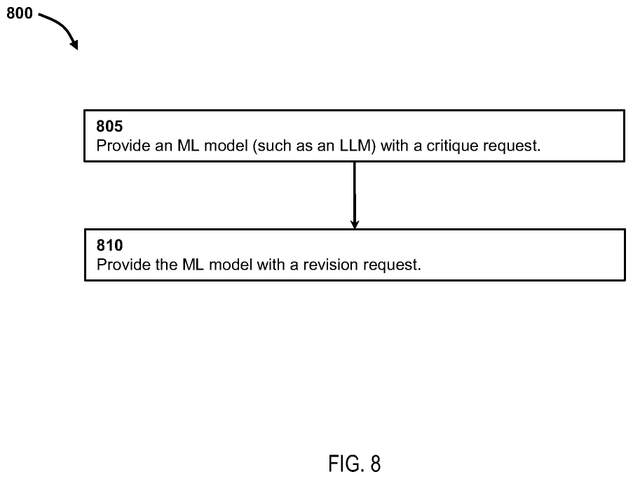

Referring now to FIG. 8, shown therein is a flowchart of a method 800 of overcoming insufficient adherence to instructions, according to an embodiment. The method 800 may be encoded as computer-executable instructions which, when executed by one or more processors, cause the computer to perform the method.

A common problem in the art is that an LLM will sometimes return a corresponding answer or result that potentially does not follow the intended ranking criteria and/or formatting criteria. This problem can be addressed by using a self-critiquing chain to improve adherence to instructions.

At 805, the method 800 includes providing a large language model (LLM) with a critique request.

In some embodiments, this would be to devise a prompt that instructs the LLM to critique the generated, listwise ranking. In the simplest case, the criteria for critiquing is implicit and no additional instructions to the LLM are necessary. Also in the simplest case, the generated list can be critiqued directly. The self-critiquing steps could therefore occur prior to an output parsing step. The LLM used here could be the same LLM as in a previously generated result, or it could be a fine-tuned LLM.

In some embodiments, the prompt can incorporate explicit, user-defined criteria or rules for critiquing the response. In some embodiments, the object being critiqued may be a derived result from the ranked list, such as the top result, after it has been mapped to a category (e.g., in a classification task).

At 810, the method 800 further includes providing the LLM with a revision request.

In some embodiments, this would be to devise a prompt that instructs the LLM to revise a generated result, given the generated critique from 805. Similarly, the LLM used here could be the same LLM as in a previously generated result, or it could be a fine-tuned LLM for the revision task.

In some embodiments, specific revision criteria could be provided to guide the LLM.

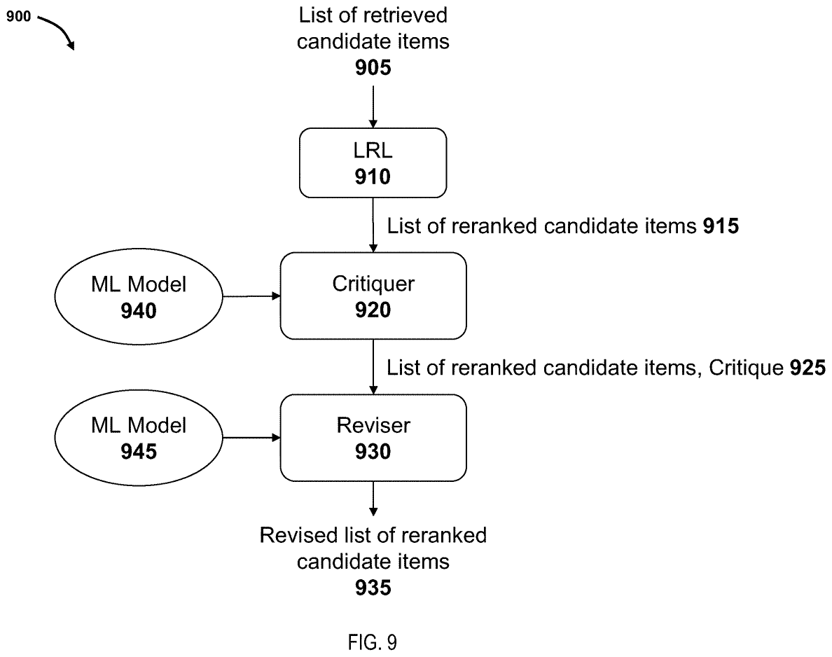

Referring now to FIG. 9, shown therein is a schematic diagram of a system 900 based on the method 800 of FIG. 8, according to an embodiment.

In the system 900, a list of retrieved candidate items 905 is provided to an LRL 910. The LRL 910 outputs a list of reranked candidate items 915 to a critiquer 920, which is powered by an ML model 940 (such as an LLM). The critiquer 920 outputs a list of reranked candidate items and a critique 925 to a reviser 930. The reviser 930, also powered by an ML model 945 (such as an LLM) outputs a revised list of reranked candidate items 935. The ML model 940 and ML model 945 may be the same ML model, or they may be separate ML models fine-tuned for the specific task of critiquing or revising, respectively.

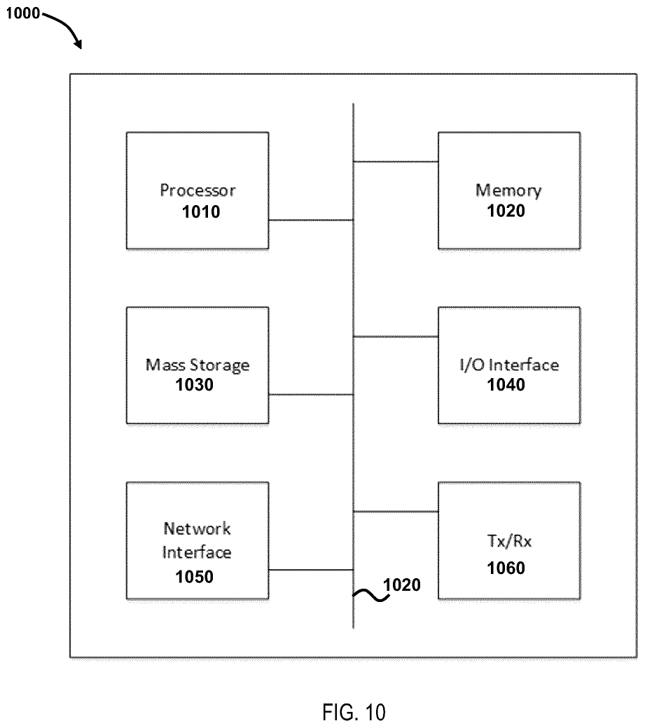

Referring now to FIG. 10, depicted therein is a block diagram of an electronic device 1000 that may perform any or all of operations of the above methods and features explicitly or implicitly described herein, according to different embodiments of the present disclosure.

For example, a computer equipped with a network function may be configured as electronic device 1000.

As shown, the device includes a processor 1010, such as a Central Processing Unit (CPU) or specialized processors such as a Graphics Processing Unit (GPU) or other such processor unit, memory 1020, non-transitory mass storage 1030, I/O interface 1040, network interface 1050, and a transceiver 1060, all of which are communicatively coupled via bi-directional bus 1070. According to certain embodiments, any or all of the depicted elements may be utilized, or only a subset of the elements. Further, the device 1000 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 1020 may include any type of non-transitory memory such as static random-access memory (SRAM), dynamic random-access memory (DRAM), synchronous DRAM (SDRAM), read-only memory (ROM), any combination of such, or the like. The mass storage element 1030 may include any type of non-transitory storage device, such as a solid-state drive, hard disk drive, a magnetic disk drive, an optical disk drive, USB drive, or any computer program product configured to store data and machine executable program code. According to certain embodiments, the memory 1020 or mass storage 1030 may have recorded thereon statements and instructions executable by the processor 1010 for performing any of the aforementioned method operations described above.

In various embodiments, the device 1000 is configured to receive input data, wherein the input data includes a query and a set of candidate items. The device 1000 is further configured to process the input data based on a contextual understanding of the input data. The device is further configured to generate output data based on the processing, wherein the output data includes candidate items ranked according to relevance to the query.

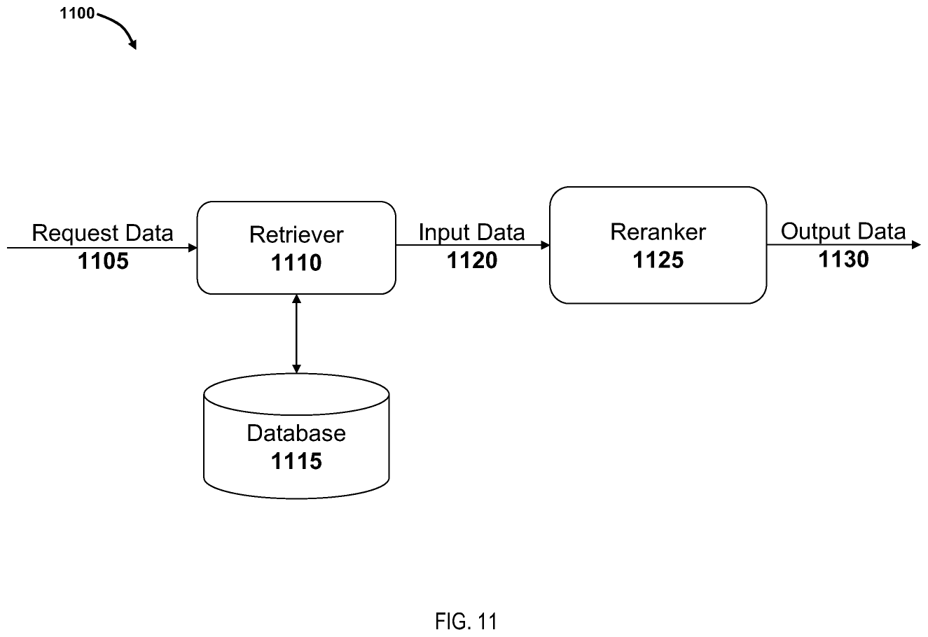

Referring now to FIG. 11, shown therein is a schematic diagram of a computer system 1100 for implementing the method 100 of FIG. 1, according to an embodiment.

The system 1100 includes a candidate item retriever module 1110, a candidate item database 1115, and a candidate item reranker module 1125.

In the system 1100, the candidate item retriever 1110 is configured to receive request data 1105. The request data 1105 includes a query and a request for a set of candidate items. Those of skill in the art will note that as terminology varies in the art, a retriever is also known by some as a ranker.

The candidate item retriever 1110 is further configured to retrieve the set of candidate items from a candidate item database 1115.

The candidate item retriever 1110 is further configured to provide input data 1120 to a candidate item ranker 1125, the input data 1120 including the query and the set of retrieved candidate items. Those of skill in the art will note that as terminology varies in the art, a reranker is also simply known by some as a ranker.

The candidate item ranker 1125 is configured to receive the input data from the candidate item retriever 1110.

The candidate item ranker 1125 is further configured to process the input data based on a contextual understanding of the input data.

The candidate item ranker 1125 is further configured to generate output data 1130 based on the processing, wherein the output data 1130 includes candidate items ranked according to relevance to the query.

In various embodiments, the system 1100 may be configured to perform any or all operations of the above methods and features explicitly or implicitly described herein, according to different embodiments of the present disclosure. It will be reasonably appreciated by those having skill in the art that the system 1100 may possess further components and functionality. For example, the system may include at least one processor, and at least one non-transitory memory having stored thereon instructions for execution by the at least one processor. The system may further include a network interface, an I/O interface, and transmission and reception capabilities.

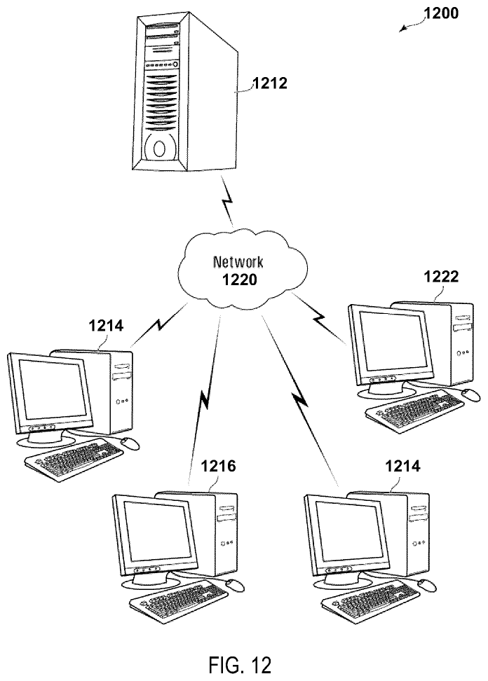

Referring now to FIG. 12, shown therein is a network system 1200 based on methods, devices and systems disclosed herein, according to an embodiment.

The network system 1200 includes server device 1212 which communicates with a plurality of user devices 1214, a plurality of database devices 1216, and a plurality of administrator devices 1218, via a network 1220. The server device 1212 also communicates with a plurality of other devices 1222, which may include, for example, financial devices or telecommunications devices. The server device 1212 may be a purpose-built machine for performing reranking with a large language model. The server device 1212 may be similar to the electronic device 200 of FIG. 2. The server device 1212 may be configured or designed specifically for performing the method 100 of FIG. 1.

The electronic device 1212, user devices 1214, database devices 1216, administrator devices 1218 and other devices 1222 may be a server computer, desktop computer, notebook computer, tablet, PDA, smartphone, or another computing device. The devices 1212, 1214, 1216, 1218, 1222 may include a connection with the network 1220 such as a wired or wireless connection to the Internet. In some cases, the network 1220 may include other types of computer or telecommunication networks. The devices 1212, 1214, 1216, 1218, 1222 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage or may be received from the Internet or other network 1220. Input device may include any device for entering information into device 1212, 1214, 1216, 1218, 1222. For example, input device may be a keyboard, keypad, cursor-control device, touchscreen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 1212, 1214, 1216, 1218, 1222 may include multiple of any one or more of processors, applications, software modules, second storage devices, network connections, input devices, output devices, and display devices.

Although devices 1212, 1214, 1216, 1218, 1222 are described with various components, one skilled in the art will appreciate that the devices 1212, 1214, 1216, 1218, 1222 may in some cases contain fewer, additional or different components. In addition, although aspects of an implementation of the devices 1212, 1214, 1216, 1218, 1222 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 1212, 1214, 1216, 1218, 1222 and/or processor to perform a particular method.

In the description that follows, devices such as electronic device 1212, user devices 1214, database devices 1216, administrator devices 1218, and user devices 1222 are described performing certain acts. It will be appreciated that any one or more of these devices may perform an act automatically or in response to an interaction by a user of that device. That is, the user of the device may manipulate one or more input devices (e.g., a touchscreen, a mouse, or a button) causing the device to perform the described act. In many cases, this aspect may not be described below, but it will be understood.

As an example, it is described below that the devices 1212, 1214, 1216, 1218, 1222 may send information to the electronic device 1212. For example, a user using a user device 1214 may manipulate one or more input devices (e.g., a mouse and a keyboard) to interact with a user interface displayed on a display of the user device 1214. Generally, the device may receive a user interface from the network 1220 (e.g., in the form of a webpage). Alternatively, or in addition, a user interface may be stored locally at a device (e.g., a cache of a webpage or a mobile application).

Electronic device 1212 may be configured to receive a plurality of information, from each of the plurality of user devices 1214, database devices 1216, administrator devices 1218, and other devices 1222. Generally, the information may comprise at least an identifier identifying the user, database, administrator, or other. For example, the information may comprise one or more of a username, e-mail address, password, or social media handle.

In response to receiving information, the electronic device 1212 may store the information in a storage database. The storage may correspond with secondary storage of the device 1212, 1214, 1216, 1218, 1222. Generally, the storage database may be any suitable storage device such as a hard disk drive, a solid-state drive, a memory card, or a disk (e.g. CD, DVD, or Blu-ray etc.). Also, the storage database may be locally connected with electronic device 1212. In some cases, the storage database may be located remotely from electronic device 1212 and accessible to electronic device 1212 across a network for example. In some cases, the storage database may comprise one or more storage devices located at a networked cloud storage provider.

The user device 1214 may be associated with a user account. Similarly, the database device 1216 may be associated with a database account, the administrator device 1218 may be associated with an administrator account, and the other device 1222 may be associated with a particular account. Any suitable mechanism for associating a device with an account is expressly contemplated. In some cases, a device may be associated with an account by sending credentials (e.g., a cookie, login, or password etc.) to the electronic device 1212. The electronic device 1212 may verify the credentials (e.g. determine that the received password matches a password associated with the account). If a device is associated with an account, the electronic device 1212 may consider further acts by that device to be associated with that account.

Experiments conducted to evaluate the performance of LRL on a variety of datasets have included the TREC DL shared tasks of three years (DL19, DL20, and DL21), as well as three non-English text retrieval tasks from MIRACL. Results indicate that LRL outperforms pointwise rerankers on the TREC DL datasets by 5.6 nDCG@10 on average over UPR, the current state of the art (SOTA) zero-shot reranker. LRL also outperformed BM25, achieving an average improvement of 15 points of nDCG@10 on a subset of MIRACL, a recent multilingual text retrieval dataset.

Given a corpus C={D₁, D₂, . . . , Dₙ} that contains a collection of documents and a query q, the task of a retriever is to return a list of k documents from C that are most relevant to query q, where k<<|C|, according to some metric. The task of a reranker is to further improve the quality of the ranked list, according to either the same or a different metric. Retrievers and rerankers together form multi-stage ranking pipelines for text ranking. Despite recent works on supervised neural retrievers have shown success in text ranking tasks, they all request a large amount of task-specific human-labeled positive query-document pairs to train a supervised model. As an aspect of the present disclosure pertains to the context of the complete zero-shot setting, where the model requires no task-specific supervised training.

BM25 is a traditional lexical retriever based on the probabilistic relevance model. It estimates query-document relevance according to the statistics of term frequency and inverse document frequency signals, which requires no supervised data and fits zero-shot constraints naturally. Contriever is an unsupervised dense retriever trained by momentum contrastive learning using pseudo query-document pairs cropped from raw texts. It also does not require task-specific supervision.

UPR uses a zero-shot question generation model to rerank the retrieved passages based on query likelihood. Concretely, UPR estimates the log-probability of whether document D is relevant to query q using a pre-trained language model to compute the average log-likelihood of the query tokens conditioned on the passage. As far as is known, {BM25, Contriever}—UPR forms the state-of-the-art zero-shot multistage ranking pipeline.

Recent work InPars and Promptagator explored using LLMs to generate synthetic queries for documents to craft positive query-document pairs as training data for retrievers or rerankers. Concurrent work HyDE uses LLMs to generate hypothetical documents for an unsupervised dense retriever. In this work, an LLM is used directly as a ranking function in a multi-stage ranking pipeline.

To demonstrate the effectiveness of LRL, existing representative unsupervised ranking pipelines BM25, Contriever, UPR are compared, as well as the proposed baseline PRL. Methods are evaluated on TREC Deep Learning passage retrieval tasks DL19, DL20 and DL21. DL19 and DL20 use the MS MARCO v1 corpus which contains 8.8 million passages and DL21 uses the MS MARCO v2 corpus which contains 138 million passages. MIRACL is a multilingual dataset that focuses on ad hoc retrieval across 18 different languages. Due to the cost of API calls for GPT3, experiments were conducted in three languages: Chinese, Swahili, and Yoruba, to verify the effectiveness of the method on non-English (both high- and low-resource) languages.

The implementation is based on the latest GPT-3 API release. For TREC DL datasets, text-davinci-003 is used for both PRL and LRL. Due to the limitation of input sequence length, LRL takes 10 candidate passages (i.e., m=10) and truncates the length of each passage to fit the length limit when necessary. To rank the candidate list with a size larger than 10 (e.g. rank top-20 passages), the progressive reranking strategy is used. For MIRACL datasets, code-davinci-002 is used, which accepts twice the input tokens of text-davinci-003. A model supporting longer input length was selected as it was observed GPT-3 tends to over-tokenize many non-English languages. For example, it produces 28 tokens from a Yoruba sentence with 8 whitespace-separated words.

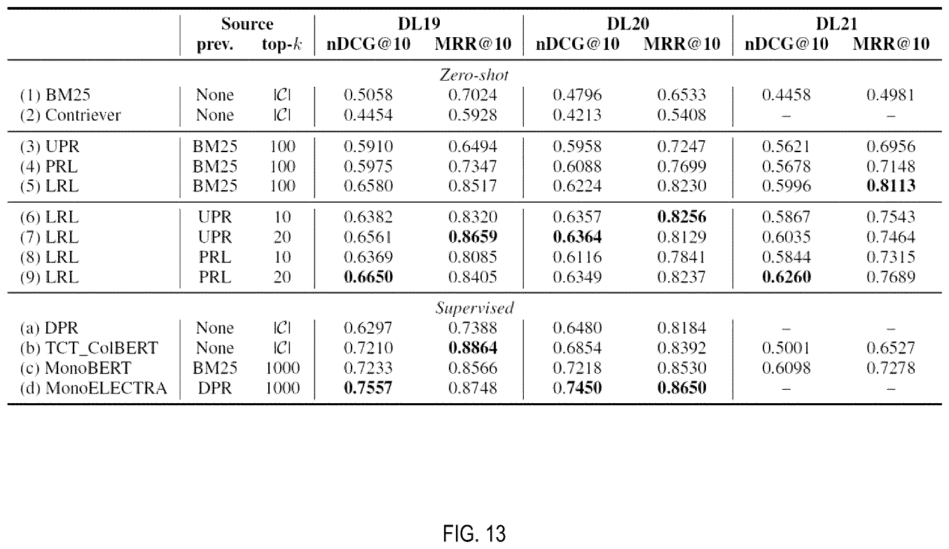

Referring now to FIG. 13, shown therein are the results of the three TREC Deep Learning (DL) datasets, where rows 1-9 compares different zero-shot ranking pipelines, and rows a-d are the results of supervised method trained on the MS MARCO training set. Such results are a practical example of the method of FIG. 1 being performed and compared to existing approaches.

Under Source columns, prev. indicates the ranking system of the previous stage, thus None for first-stage retrievers. Rows 1 and 2 are baselines using two first-stage retrievers, BM25 and Contriever. Rows 3-5 shows results of different LLMs reranking top-100 candidate documents retrieved by BM25, including the current state of the art (SOTA) UPR, a proposed baseline PRL, and the proposed listwise reranker LRL. BM25 is used as the first-stage retriever since it achieves higher effectiveness on DL19 and DL20. Results show that LRL is more effective than the pointwise rerankers on all three datasets: Take nDCG@10 as an example, on average, LRL is around 5.6 and 3.5 points higher than UPR and PRL respectively.

Rows 6-9 present the results of using LRL to rerank the top-10/20 documents from UPR and PRL, as an additional reranking stage. This setting is inspired by the multi-stage ranking proposed in duoBERT. In this case, progressive reranking over a too long list can be avoided for better efficiency. Results show that it can achieve further improvements over pointwise rerankers consistently. For example, by reranking the top-20 PRL results, as in row (9), LRL improves the nDCG@10 and MRR@10 by 5.0 and 7.1 points on average. This further supports the claim that ranking based on a list of documents indeed provides better signal than computing relevance scores for each of the documents individually.

Comparing the best LRL pipelines with the supervised ranking pipelines, it is plain to see the effectiveness of the LRL, which does not require any task-specific training, even outperform some of the supervised dense retrievers such as DPR, which is trained on a large amount of in-domain training data, as shown on row (a). However, it is noticed that there is still a gap to the more compound supervised ranking pipelines, for example, the TCT_ColBERT.

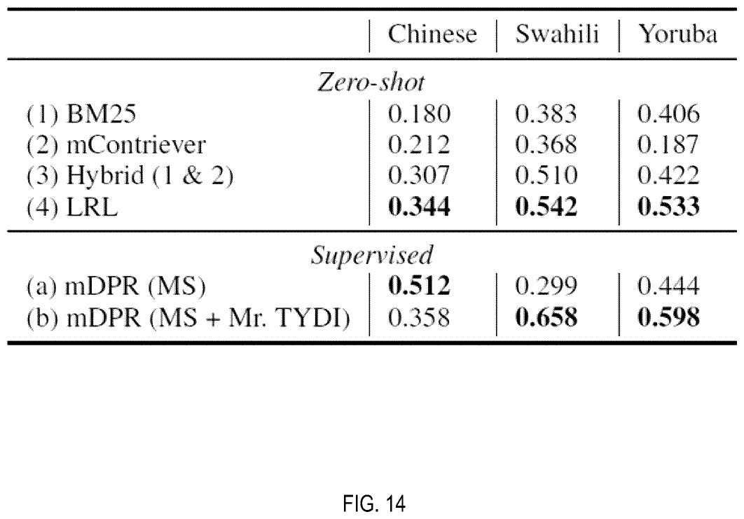

The training of GPT-3 does not restrict the languages of training data, which means the proposed method is able to be directly applied on non-English datasets. FIG. 14 depicts the results of three datasets from MIRACL. The top-20 retrieval results are reranked from the system on row 3, which is the hybrid of BM25 and mContriever on rows 1-2. Under supervised, mDPR (MS) is trained on MS MARCO, and mDPR (MS+Mr. TYDI) is further trained with Mr. TYDI. On the three datasets, LRL outperforms the hybrid baseline by 3.7, 3.2, and 11.1 points respectively, demonstrating the effectiveness of the LRL reranker of the present disclosure on multilingual retrieval.

The present disclosure proposes an LRL, a listwise zero-shot reranker utilizing LLM that adopts a new simple and effective paradigm for reranking. The present disclosure illustrates its improvements over the SOTA zero-shot pointwise rerankers on web search datasets and demonstrates its effectiveness across languages.

The relatively high latency of GPT-3 and restricted input length made the major limitation of this work. At the current stage, LRL is hard to be used to rerank long lists such as top-1000 candidates and extremely long passages such as entire web pages. The focus is therefore on improving top-ranking results (e.g., top-20) in a multi-stage ranking pipeline. Another limitation is that the GPT-3 model is not open-sourced. Besides, the unknown bias of the ranking model may be a potential risk for the system.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include a number of instructions that enable a computer device to execute operations for configuring or programming a digital logic apparatus in accordance with embodiments of the present disclosure.

While the above description provides examples of one or more apparatus, methods, or systems, it will be appreciated that other apparatus, methods, or systems may be within the scope of the claims as interpreted by one of skill in the art.

1. A method of ranking digital information in an application, the method comprising executing via a computer system comprising at least one processor:
receiving input data including an object of interest and a set of candidate items;
processing, by a machine learning model, the input data based on a contextual understanding of the input data;
generating output data based on the processing, wherein the output data includes candidate items ranked according to relevance to the object of interest; and
applying the output data as ranked information in the application.

2. The method of claim 1, wherein the machine learning model is a language model.

3. The method of claim 1, wherein the object of interest is a query.

4. The method of claim 1, wherein the application is a natural language understanding task.

5. The method of claim 4, wherein the natural language understanding task is at least one of: search, question answering, fact verification, entity linking, content recommendation, and classification.

6. The method of claim 1, wherein processing the input data uses partition-based ranking.

7. The method of claim 1, further comprising repeating the method using at least one randomized variation of the set of candidate items to generate at least one additional output data.

8. The method of claim 7, further comprising aggregating the output data and the at least one additional output data to obtain an averaged output data.

9. The method of claim 1, further comprising receiving a critique request to generate a critique of the output data.

10. The method of claim 9, further comprising receiving a revision request to generate revised output data based on the critique of the output data.

11. The method of claim 1, wherein the input data further includes example data to refine the processing.

12. A device comprising:
a network interface;
a processor;
a non-transitory memory having stored thereon computer-executable instructions which, when executed by the processor, configure the device to:
receive input data including an object of interest and a set of candidate items;
process, by a machine learning model, the input data based on a contextual understanding of the input data; and
generate output data based on the processing, wherein the output data includes candidate items ranked according to relevance to the object of interest.

13. (canceled)

14. The device of claim 12, wherein the device is further configured to repeat the receive, process, and generate steps using at least one randomized variation of the set of candidate items to generate at least one additional output data.

15. The device of claim 14, wherein the device is further configured to aggregate the output data and the at least one additional output data to obtain an averaged output data.

16. (canceled)

17. (canceled)

18. A system comprising:
a data storage device for storing a candidate item database;
a processor in communication with the data storage device, the processor configured to execute:
a candidate item retriever configured to:
receive request data including an object of interest and a request for a set of candidate items;
retrieve the set of candidate items from the candidate item database; and
provide input data to a candidate item reranker, wherein the input data includes the object of interest and the set of candidate items; and
a candidate item reranker configured to;
receive the input data from the candidate item retriever;
process, by a machine learning model, the input data based on a contextual understanding of the input data; and
generate output data based on the processing, wherein the output data includes candidate items reranked according to relevance to the object of interest.

19. The system of claim 18, wherein processing the input data is repeatedly performed on a shifting subset of the set of candidate items.

20. The system of claim 18, wherein the candidate item reranker is further configured to repeat the receive, process, and generate operations using at least one randomized variation of the set of candidate items to generate at least one additional output data.

21. The system of claim 20, wherein the candidate item reranker is further configured to aggregate the output data and the at least one additional output data to obtain an averaged output data.

22. The system of claim 18, wherein the candidate item reranker is further configured to receive a critique request to generate a critique of the output data.

23. The system of claim 22, wherein the candidate item reranker is further configured to receive a revision request to generate revised output data based on the critique of the output data.

24. (canceled)
